(19) United States
(12) Patent Application Publication
(10) Pub. No.: US 2016/0063412 A1
(43) Pub. Date: Mar. 3, 2016

(54) METHOD FOR DISTRIBUTED GOAL-DRIVEN PROGRAMMING

(71) Applicant: General Electric Company, Schenectady, NY (US)

(72) Inventors: Benjamin Edward Beckmann, Niskayuna, NY (US); Li Zhang, Clifton Park, NY (US); Adam Joseph McCann, Schenectady, NY (US)

(21) Appl. No.: 14/470,773

(22) Filed: Aug. 27, 2014

(51) Int. Cl. G06Q 10/06; H04L 12/58

(52) U.S. Cl. CPC G06Q 10/06313; H04L 51/02

(57) ABSTRACT

A system comprising a computer-readable storage medium storing at least one program, and a method for distributed goal-driven programming in the context of a publisher-subscriber model is presented. Example embodiments involve communicating a subscriber goal to a publisher related to data produced by the publisher and subscribed to by one or more subscribers. A production monitor may then modify resource allocations used for producing the data such that the data may be produced in accordance with the subscriber goal. The publisher may then produce the data in accordance with the subscriber goal, and the produced data may be published to the one or more subscribers.

### TECHNICAL FIELD

The subject matter disclosed herein relates to data processing. In particular, example embodiments may relate to distributed goal-driven programming.

### BACKGROUND

In the field of software architecture, the publisher-subscriber model (also referred to as the “publish-subscribe pattern”) provides a data exchange paradigm whereby publishers provide certain types of messages to subscribers who have expressed interest in messages of that type. In the publisher-subscriber model, the publishers do not configure messages to be sent to specific subscribers, and the publishers need not have knowledge of what, if any, subscribers there may be. Instead, the subscribers simply opt in or subscribe to a certain classification of messages, and such messages are automatically provided to the subscribers upon being produced by the publisher. The classification of messages may be based on message topics, message attributes, or a combination of both.

In the current publisher-subscriber model, the publisher is responsible for deciding how often messages are shared and for defining the classifications of messages to which a subscriber may subscribe. The subscribers, on the other hand, may only specify a time period of interest and a publisher-defined classification of messages. Currently, no mechanism exists to allow subscribers to specify a desired objective of a publisher or otherwise affect the manner in which the messages are produced by the publishers. In this way, the adaptation of the current publish-subscribe architectures is limited because the behavior of a publisher cannot be dynamically adapted or configured to suit the needs of the subscriber.

### BRIEF DESCRIPTION OF THE DRAWINGS

Various ones of the appended drawings merely illustrate example embodiments of the present inventive subject matter and cannot be considered as limiting its scope.

FIG. 1 is an architecture diagram depicting a publisher-subscriber system configured for dynamic adaptation of a publisher to meet subscriber goals, according to an example embodiment.

FIG. 2 is an interaction diagram depicting example exchanges between a plurality of subscribers, a data-centric middleware, and a publisher, consistent with some embodiments.

FIG. 3 is a block diagram illustrating various modules comprising a data-centric middleware, which is provided as part of the publisher-subscriber system, consistent with some embodiments.

FIG. 4 is a block diagram illustrating various modules comprising a publisher, which is provided as part of the publisher-subscriber system, consistent with some embodiments.

FIG. 5 is a flowchart illustrating a method for optimizing a plurality of subscriber goals and provisioning data in accordance with respective subscriber goals, consistent with some embodiments.

FIG. 6 is a flowchart illustrating a method for dynamically modifying resource allocations of a publisher to produce data in accordance with subscriber goals, consistent with some embodiments.

FIG. 7 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Aspects of the present disclosure involve communicating subscriber goals to a publisher through a simple standard interface. In this manner, the behavior of a publisher can be dynamically adapted or configured based on the goals of the subscriber. Publishers are empowered to perform adaptations as long as goals are achieved, which may have the technical effect of maintaining support for both subscriber and administrative goals at the publisher level while also providing publishers the freedom to optimize their own individual behavior. The example embodiments described herein may also provide for the application of administrator specified cross-cutting goals (e.g., energy conservation) in conjunction with subscriber goals.

In example embodiments, a subscriber may subscribe to a published topic, and along with this subscription, the subscriber also states a goal for the subscription. For example, a subscriber goal may specify a particular power consumption goal (e.g., power consumption not to exceed a certain threshold) for a publisher operating as part of a smart phone or other mobile device. In another example, a subscriber goal may specify that a particular load on a website associated with the publisher be maintained (e.g., 50% above the average load). Subscriber goals may be dynamically added, modified, or deleted. In embodiments in which there are multiple subscribers with a set of goals, a goal-driven middleware can aggregate and optimize the set of goals before passing a modified goal set on to the publisher, which allows for a negotiation between the subscribers and the goal-driven middleware without increasing the complexity of the publisher.

The set of logic (e.g., an algorithm) used by the publisher to generate publishable values need not be aware of subscriber goals. Instead, a production monitor included in the publisher system receives the subscriber goals and has the ability to modify resource allocations to meet the subscriber goals. In addition, administrative goals can also be met through production monitor resource allocation modifications. The publishers may then produce data using the modified resource allocations and simply publish the produced data through a publication application programming interface (API). Behind the publication API, a message with the published data is sent to the goal-driven middleware and another message regarding the publication of the data is sent to the production monitor.

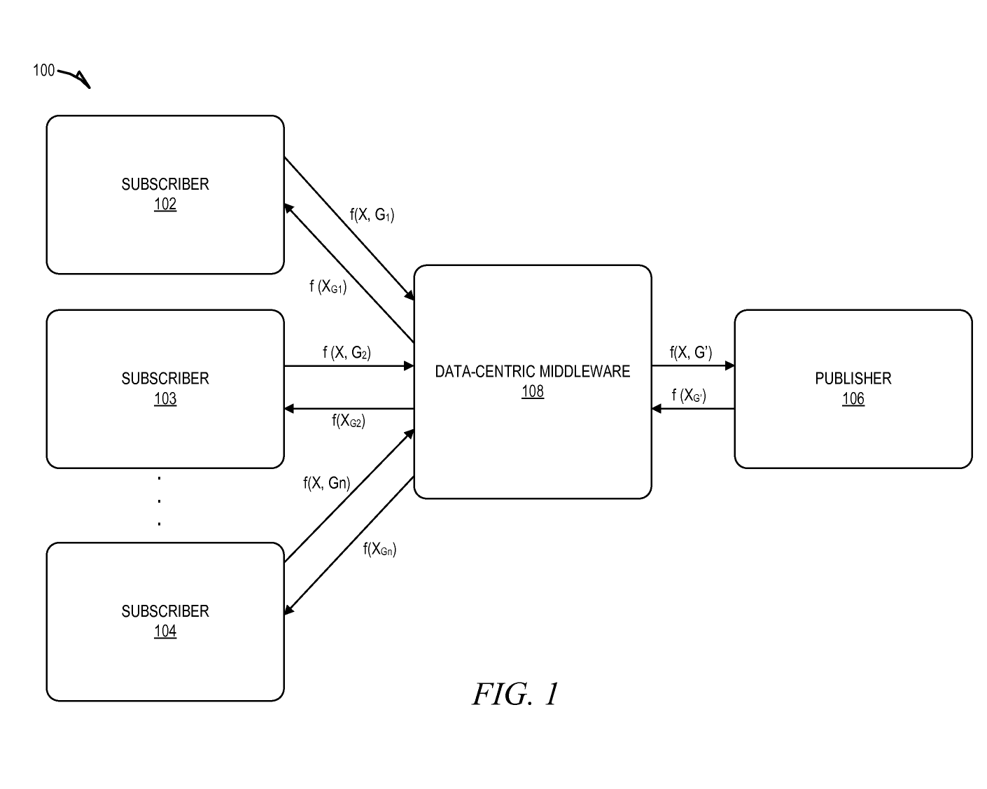

FIG. 1 is an architecture diagram depicting a publisher-subscriber system 100 configured for dynamic adaptation of a publisher to meet subscriber goals, according to an example embodiment. As is understood by skilled artisans in the relevant computer and Internet-related arts, each component (e.g., a module or engine) illustrated in FIG. 1 represents a set of executable software instructions and the corresponding hardware (e.g., memory and processor) for executing the instructions. To avoid obscuring the inventive subject matter with unnecessary detail, various functional components (e.g., modules and engines) that are not germane to conveying an understanding of the inventive subject matter have been omitted from FIG. 1. However, a skilled artisan will readily recognize that various additional functional components may be supported by the publisher-subscriber system 100 to facilitate additional functionality that is not specifically described herein. Furthermore, the various functional modules and engines depicted in FIG. 1 may reside on a single computer (e.g., a server), or may be distributed across several computers in various arrangements. Additionally, while a portion of the components of FIG. 1 are discussed in the singular sense, it will be appreciated that in other embodiments multiple instances of each component may be employed.

The publisher-subscriber system 100 facilitates an indirect communication between components through publishing and subscribing to messages managed by an intermediate component. The messages typically include a subject (e.g., a topic) and a structure comprising various fields and values that carry data of interest.

As shown, the publisher-subscriber system 100 includes subscribers 102-104 who may subscribe to messages produced by a publisher 106. The subscribers 102-104 may correspond to applications, client devices, or components of an embedded system. The publisher 106 may correspond to an application, a client device, a server computer, a database, or a component of an embedded system.

Each of the subscribers 102-104 may be communicatively coupled to a data-centric middleware 108, which is responsible for processing subscriptions. The subscribers 102-104 may subscribe to messages by submitting a subscription request through an interface (e.g., local or remote calls to an application program interface (API)) provided by the data-centric middleware 108. The subscription requests specify data of interest, which is denoted in FIG. 1 by “X,” along with a time period of interest (e.g., 5 hours). The subscription requests may also identify the identity of the subscribers 102-104, publishers 106, or data-centric middleware 108. In addition, each field included in the subscription requests (e.g., data of interest, time period, and identifiers) may have multiple possible values. For example, the time period of interest includes both the duration and length or a timeout.

The subscription requests additionally specify one or more subscriber goals for the production of the data desired by the subscriber, which are denoted in FIG. 1 as “G₁,” “G₂,” and “Gₙ,” respectively. The subscriber goals may relate to the characteristics or attributes of the data itself or to the operation of an associated system in which the publisher 106 is embedded. Multiple goal types may be supported. For example, the subscriber goals may specify quality (e.g., provide fresh data); durability (e.g., provide multiple data replicates from different sources); frequency (e.g., rate of production); rules (e.g., interest in data only when a parameter's threshold is met); range (e.g., provide discretized data based on range); or history (e.g., a time window of available data). Subscriber goals may be selected from a set of available goals (e.g., drop-down menu) provided by the subscription interface or the subscriber goals may be independently specified by the subscribers (e.g., via text field).

In some embodiments, the data-centric middleware 108 may provide server-side functionality, via a network (e.g., the Internet), to subscribers that are client devices. In these instances, such client devices may interface with the data-centric middleware 108 through a connection with the network (e.g., the Internet or a wide area network (WAN)), and depending on the form of the client device, any of a variety of types of connection and networks may be employed. For example, the connection may be Code Division Multiple Access (CDMA) connection, a Global System for Mobile communications (GSM) connection, or other type of cellular connection. Such a connection may employ any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks).

In another example, the connection may be Wireless Fidelity (Wi-Fi, IEEE 802.11x type) connection, a Worldwide Interoperability for Microwave Access (WiMAX) connection, or another type of wireless data connection. In such an embodiment, the network may include one or more wireless access points coupled to a local area network (LAN), a WAN, the Internet, or other packet-switched data network. In yet another example, the connection may be a wired connection, for example an Ethernet link, and the network may be a LAN, a WAN, the Internet, or other packet-switched data network.

Upon receiving the subscription requests from each of the subscribers 102-104, the data-centric middleware 108 may optimize the subscriber goals to create an optimized goal, which is denoted by “G′” in FIG. 1. The data-centric middleware 108 then provides the optimized goal to the publisher 106. In response, the publisher 106 produces the requested data in accordance with the optimized goal and publishes the data (denoted by “X_{G′}”) to the data-centric middleware 108. The data-centric middleware 108, in turn, provisions the data to the subscribers 102-104 in accordance with each subscriber's respective goal (this data is denoted in FIG. 1 by “X_{G1},” “X_{G2},” and “X_{Gn},” respectively).

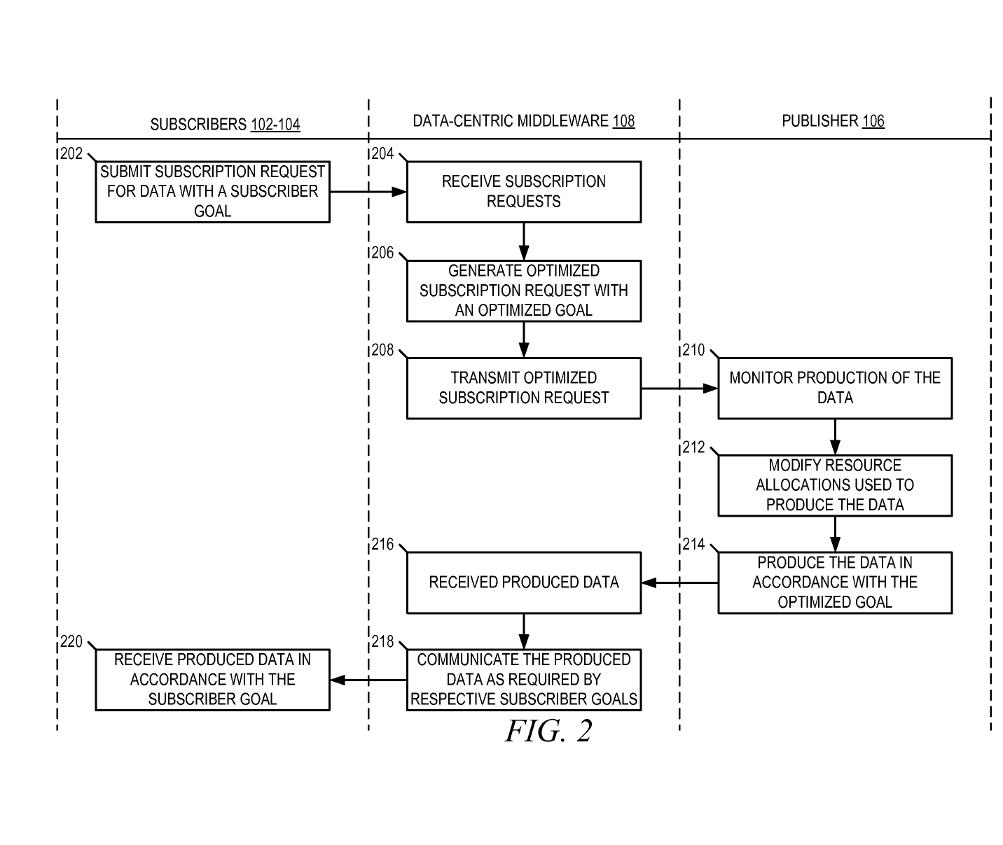

FIG. 2 is an interaction diagram depicting example exchanges between the subscribers 102-104, the data-centric middleware 108, and the publisher 106, consistent with some embodiments. As shown, the process begins at operation 202 with each of the subscribers 102-104 submitting a subscription request for data with a subscriber goal. The subscription request may be submitted through an interface (e.g., API, graphical user interface (GUI), or an administrative console) provided, for example, by the data-centric middleware 108. In an example, the subscribers 102-104 correspond to an image-consuming application and the publisher 106 corresponds to a camera or other device with embedded image-capturing capability. In this example, each of the subscribers 102-104 may request image data (the data of interest) from the publisher 106, with the subscriber 102 specifying a goal of 30 frames per second (fps), the subscriber 103 specifying a goal of 10 fps, and the subscriber 104 specifying a goal of 15 fps.

At operation 204, the data-centric middleware 108 receives the subscription requests that include each of the subscribers' goals. At operation 206, the data-centric middleware 108 generates an optimized subscription request with an optimized goal based on the multiple subscriber goals included in the subscription requests received from the subscribers 102-104. In this manner, the goals of multiple subscribers can be aggregated and optimized before being communicated to the publisher 106, allowing for negotiation between subscribers 102-104 and the data-centric middleware 108 without increasing the complexity of the publisher 106. In determining the optimized goal, the data-centric middleware 108 may select the most favorable subscriber goal from the multiple received subscriber goals associated with the data of interest. To further the image data example from above, the data-centric middleware 108 may select 30 fps, as it is the highest-value subscriber goal, as the optimized goal. At operation 208, the data-centric middleware 108 transmits the optimized subscription request to the publisher 106.

The publisher 106 may initiate the production of the data in response to receiving the optimized subscription request, or the initiation of the production of the data may be an operation that is independent of whether a subscription to the data exists. At operation 210, the publisher continuously monitors the production of data. At operation 212, the publisher 106 modifies the resource allocations used to produce the data of interest such that the data is produced in accordance with the optimized goal, at operation 214. The specific manner in which the resources are allocated is inconsequential as long as the publisher 106 produces the data in accordance with the optimized goal. If a publisher 106 is unable to meet the optimized goal, the publisher 106 may negotiate with the data-centric middleware 108 to reduce the optimized goal to a level that the publisher is capable of achieving. Following the image data example, the publisher 106 may modify the resource allocations (e.g., adjusting the allocated CPU) used to produce the image data to produce the image data at the optimized goal of 30 fps.

At operation 216, the data-centric middleware 108 receives the data produced by the publisher 106 that is in accordance with the optimized goal (e.g., image data at 30 fps). At operation 218, the data-centric middleware 108 may communicate the produced data to each of the subscribers 102-104 according to the respective subscriber goals. Each of the subscribers 102-104 receives the produced data in accordance with its respective subscriber goal, at operation 220. Furthering the image data example from above, the data-centric middleware 108 may provide the subscriber 102 with the image data at 30 fps, the subscriber 103 with the image data at 10 fps, and the subscriber 104 with the image data at 15 fps.

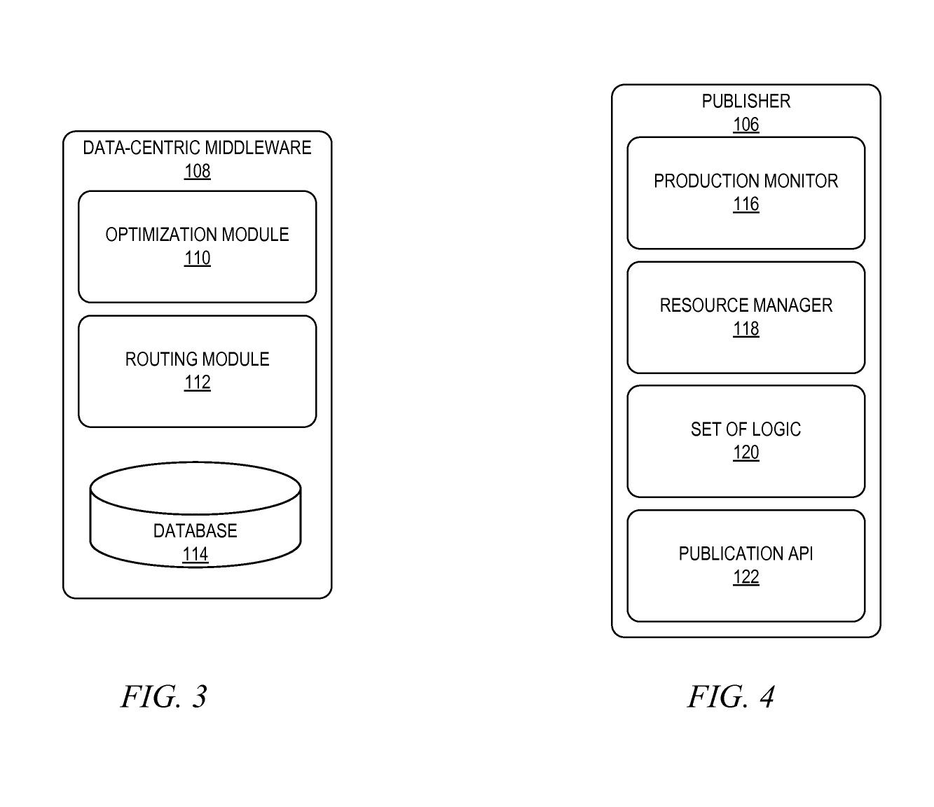

FIG. 3 is a block diagram illustrating various modules comprising a data-centric middleware 108, which is provided as part of the publisher-subscriber system 100, consistent with some embodiments. It shall be appreciated that while the modules of FIG. 3 are discussed in the singular sense, in other embodiments multiple instances of one or more of the modules may be employed.

The data-centric middleware 108 is responsible for subscription management and message routing. To this end, the data-centric middleware 108 includes an optimization module 110, and a routing module 112, which are configured to communicate with each other (e.g., via a bus, shared memory, a switch, or application programming interfaces (APIs)). The optimization module 110 and the routing module 112 may, furthermore, access a database 114, and the optimization module 110 and the routing module 112 may be in communication with the various components of the publisher 106.

The optimization module 110 may receive subscription requests from the subscribers 102-104, and communicate the subscriber goals contained therein to the publisher 106. In some instances, the optimization module 110 may receive multiple subscription requests for certain data of interest, with each subscription request including a different subscriber goal. In these instances, the optimization module 110 may generate an optimized goal and communicate the optimized goal to the publisher 106. A record of each of the subscription requests received by the optimization module 110 may be stored in the database 114 along with any corresponding subscriber goals.

The routing module 112 receives the data of interest produced by the publisher 106 and routes it to the appropriate subscriber. In instances in which the data of interest produced by the publisher 106 is in accordance with an optimized goal, the routing module 112 may be responsible for routing the data of interest in accordance with the respective goals of each subscriber. The routing module 112 may access the records of subscriptions stored in the database 114 to determine the appropriate subscriber and subscriber goals during the provisioning of data of interest.

FIG. 4 is a block diagram illustrating various modules comprising a publisher 106, which is provided as part of the publisher-subscriber system 100, consistent with some embodiments. As shown in FIG. 1, the publisher 106 may include a production monitor 116, a resource manager 118, a set of logic 120, and a publication API 122, which are configured to communicate with each other (e.g., via a bus, shared memory, a switch, or application programming interfaces (APIs)). It shall be appreciated that while the modules of FIG. 4 are discussed in the singular sense, in other embodiments multiple instances of one or more of the modules may be employed.

The production monitor 116 is responsible for monitoring and managing the production of the data of interest. In particular, the production monitor 116 is responsible for ensuring that data of interest is produced in accordance with subscriber and administrative goals. To this end, the production monitor 116 may configure resource allocations of the publisher 106 such that data is produced in accordance with one or more subscriber goals, one or more administrative goals, or various combinations of subscriber and administrative goals.

The resource manager 118 manages the computational resources (e.g., hardware and software) allocated to the set of logic 120, which actually produces the data of interest. In some embodiments, the production monitor 116 may work in conjunction with the resource manager 118 to modify the resource allocations used to produce data (e.g., hardware and software resources) to ensure that the data is produced in accordance with a subscriber goal. The data produced by the publisher 106 using the set of logic 120 may be pushed through the publication API 122, which provides the data-centric middleware 108 with programmatic access to the publisher 106 via a programmatic interface.

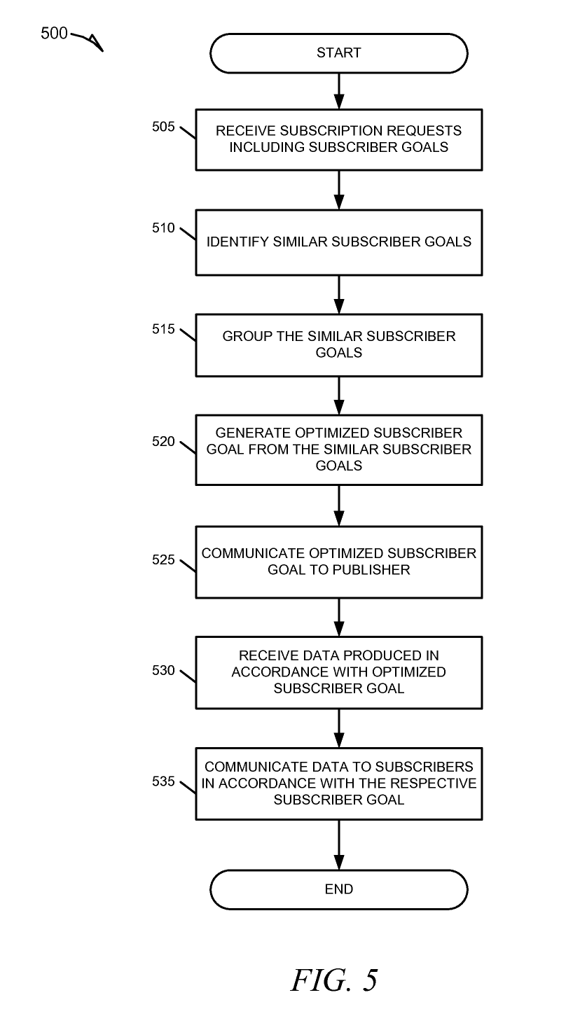

FIG. 5 is a flowchart illustrating a method 500 for optimizing a plurality of subscriber goals and provisioning data in accordance with the respective subscriber goals, consistent with some embodiments. The method 500 may be embodied in computer-readable instructions for execution by one or more processors such that the steps of the method 500 may be performed in part or in whole by the components of the data-centric middleware 108, and accordingly, the method 500 is described below by way of example with reference thereto. However, it shall be appreciated that the method 500 may be deployed on various other hardware configurations and is not intended to be limited to the data-centric middleware 108.

At operation 505, the optimization module 110 receives subscription requests from a plurality of subscribers (e.g., subscribers 102-104) for data of interest, wherein each subscription request includes a subscriber goal. Each of the subscriber goals may define an outcome for the production of the data specified by the respective subscriber. The outcomes may be a format or characteristic of the data itself or an operating constraint of a system in which the publisher or subscriber is embedded or with which the publisher or subscriber is otherwise associated. A record of the subscription requests received from the plurality of subscribers may be stored by the data-centric middleware 108 in the database 114.

At operation 510, the optimization module 110 identifies similar subscriber goals from the subscriber goals received from the plurality of subscribers. For example, the optimization module 110 may identify all subscriber goals related to a particular concept, regardless of any particular values included therewith. At operation 515, the optimization module 110 may group the similar subscriber goals. At operation 520, the optimization module 110 generates an optimized subscriber goal from the similar subscriber goals. The generation of the optimized subscriber goal may comprise selecting the most favorable subscriber goal from the similar subscriber goals as the optimized subscriber goal.

At operation 525, the optimization module 110 communicates the optimized subscriber goal to the publisher 106 as part of a subscription request. In turn, the publisher 106 may produce the data of interest in accordance with the optimized subscriber goal by modifying resource allocations of the logic used to produce the data of interest. The particular manner in which the publisher 106 may modify such resource allocations is unrestricted so long as the publisher 106 meets the optimized goal in doing so.

At operation 530, the routing module 112 receives the data produced by the publisher 106 in accordance with the optimized goal. The routing module 112 may receive the data produced by the publisher 106 through the publication API 122. The routing module 112 may access the subscription request records stored in the database 114 and at operation 535, communicate the data to the subscribers in accordance with the respective subscriber goals included therein.

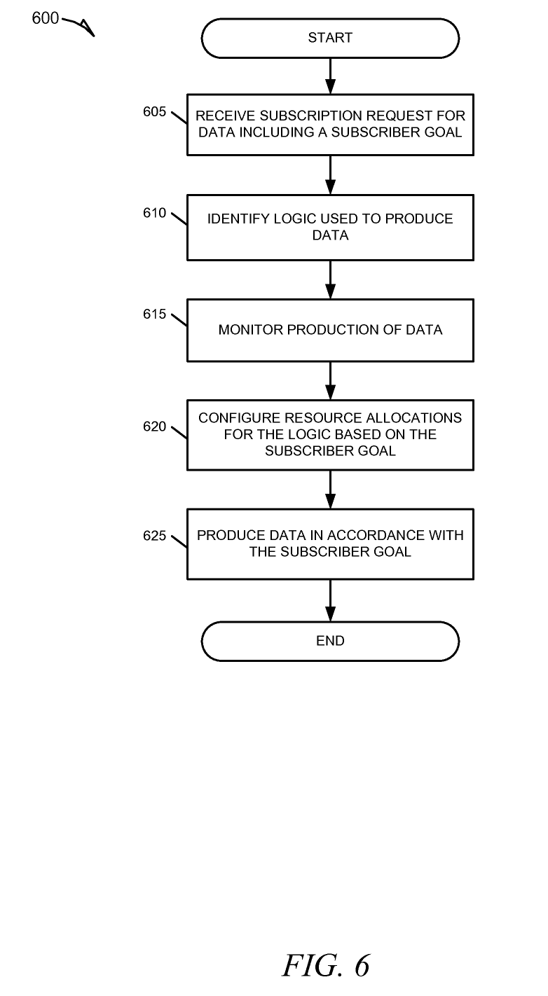

FIG. 6 is a flowchart illustrating a method 600 for dynamically modifying resource allocations of a publisher to produce data in accordance with subscriber goals, consistent with some embodiments. The method 600 may be embodied in computer-readable instructions for execution by one or more processors such that the steps of the method 600 may be performed in part or in whole by the components of the publisher 106, and accordingly, the method 600 is described below by way of example with reference thereto. However, it shall be appreciated that the method 600 may be deployed on various other hardware configurations and is not intended to be limited to the specific components of the publisher 106 described herein.

At operation 605, the production monitor 116 receives a subscription request (e.g., from the data-centric middleware 108) for data that includes a subscriber goal. The subscriber goal may be a subscriber goal from an individual subscriber, or an optimized goal generated by the data-centric middleware 108 from a plurality of subscriber goals.

At operation 610, the production monitor 116 identifies the set of logic 120 used to produce the data, and begins monitoring the production of the data by the set of logic 120, at operation 615. At operation 620, the production monitor 116 configures the resources (e.g., hardware and software resources) allocated to the set of logic 120 such that the data is produced in accordance with the subscriber goal. For example, the production monitor 116 may increase or decrease the amount of CPU or RAM allocated to the production of the data. In this manner, the set of logic 120 used to produce the eventually published values (e.g., the data) need not be aware of the subscriber goals, and the production monitor 116 may reallocate resources in whatever manner is deemed fit for the operation of the publisher 106. In some embodiments, the modifying of the resource allocations may include signaling or otherwise causing the resource manager 118 to reallocate the resources.

In some embodiments, the production monitor 116 may continuously monitor the production of the data by the set of logic 120, and in response to determining that the production of the data is not in accordance with the subscriber goals (e.g., above or below the goals), the production monitor 116 may iteratively signal the resource manager 118 to adjust resource allocations until the production monitor 116 determines that the data is produced in accordance with the subscriber goals.

In some instances, the resource allocation configurations performed by the production monitor 116 may also take into account one or more administrative goals. These administrative goals may be a characteristic of the data or operating constraint established by an administrator of the publisher 106 who is independent of the subscribers to the data produced by the publisher 106. In these instances, the production monitor 116 may access the one or more administrative goals from a database associated with the publisher 106, and at operation 620, the production monitor 116 may configure the resource allocations such that the data is produced in accordance with both the subscriber goals and the one or more administrative goals.

At operation 625, the set of logic 120 may produce the data in accordance with the subscriber goal (e.g., individual subscriber goal or optimized subscriber goal) and publish the data through the publication API 122. From the publication API 122, a message with the published data is sent to the data-centric middleware 108 and provisioned accordingly. Further, the publication API 122 may also send a message to the production monitor 116 indicating that the data has been published.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Machine Architecture and Machine-Readable Medium

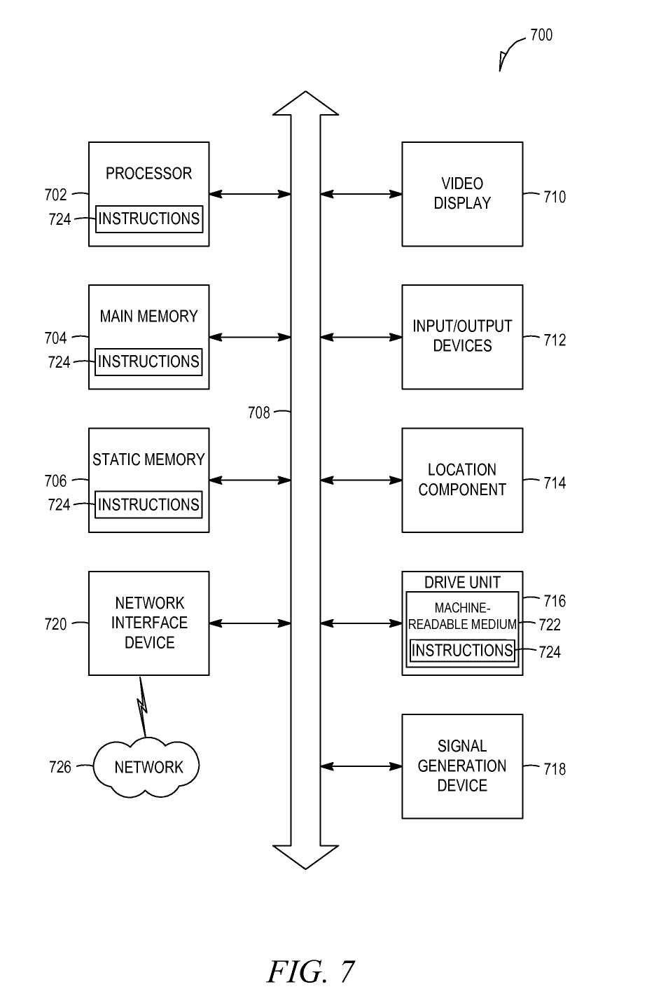

FIG. 7 is a diagrammatic representation of a machine in the example form of a computer system 700 within which a set of instructions for causing the machine to perform any one or more of the methodologies discussed herein may be executed. The computer system 700 may correspond to any of the subscribers 102-104, the publisher 106, or the data-centric middleware 108, consistent with some embodiments. The computer system 700 may include instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display 710 (e.g., a liquid crystal display (LCD) or a cathode ray tube (CRT)). The computer system 700 also includes one or more input/output (I/O) devices 712, a location component 714, a drive unit 716, a signal generation device 718 (e.g., a speaker), and a network interface device 720. The I/O devices 712 may, for example, include a keyboard, a mouse, a keypad, a multi-touch surface (e.g., a touchscreen or track pad), a microphone, a camera, and the like.

The location component 714 may be used for determining a location of the computer system 700. In some embodiments, the location component 714 may correspond to a GPS transceiver that may make use of the network interface device 720 to communicate GPS signals with a GPS satellite. The location component 714 may also be configured to determine a location of the computer system 700 by using an internet protocol (IP) address lookup or by triangulating a position based on nearby mobile communications towers. The location component 714 may be further configured to store a user-defined location in main memory 704 or static memory 706. In some embodiments, a mobile location enabled application may work in conjunction with the location component 714 and the network interface device 720 to transmit the location of the computer system 700 to an application server or third party server for the purpose of identifying the location of a user operating the computer system 700.

In some embodiments, the network interface device 720 may correspond to a transceiver and antenna. The transceiver may be configured to both transmit and receive cellular network signals, wireless data signals, or other types of signals via the antenna, depending on the nature of the computer system 700.

### Machine-Readable Medium

The drive unit 716 includes a machine-readable medium 722 on which is stored one or more sets of data structures and instructions 724 (e.g., software) embodying or used by any one or more of the methodologies or functions described herein. The instructions 724 may also reside, completely or at least partially, within the main memory 704, the static memory 706, and/or the processor 702 during execution thereof by the computer system 700, with the main memory 704, the static memory 706, and the processor 702 also constituting machine-readable media.

Consistent with some embodiments, the instructions 724 may relate to the operations of an operating system (OS). Depending on the particular type of the computer system 700, the OS may, for example, be the iOS® operating system, the Android® operating system, a BlackBerry® operating system, the Microsoft® Windows® Phone operating system, Symbian® OS, or webOS®. Further, the instructions 724 may relate to operations performed by applications (commonly known as “apps”), consistent with some embodiments. One example of such an application is a mobile browser application that displays content, such as a web page or a user interface using a browser.

While the machine-readable medium 722 is shown in an example embodiment to be a single medium, the term “machine-readable medium” may include a single medium or multiple media (e.g., a centralized or distributed database, and/or associated caches and servers) that store the one or more data structures or instructions 724. The term “machine-readable medium” shall also be taken to include any tangible medium that is capable of storing, encoding, or carrying instructions (e.g., instructions 724) for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 724 may further be transmitted or received over a network 726 using a transmission medium. The instructions 724 may be transmitted using the network interface device 720 and any one of a number of well-known transfer protocols (e.g., HTTP). Examples of communication networks include a LAN, a WAN, the Internet, mobile telephone networks, plain old telephone service (POTS) networks, and wireless data networks (e.g., WiFi and WiMax networks). The term “transmission medium” shall be taken to include any intangible medium that is capable of storing, encoding, or carrying the instructions 724 for execution by the machine, and includes digital or analog communications signals or other intangible media to facilitate communication of such software.

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A method comprising:
receiving a subscription request for data including a subscriber goal, the subscriber goal specifying an outcome with respect to production of the data;
identifying a set of logic used by a publisher to produce the data;
configuring resource allocations of the set of logic such that the data is produced in accordance with the subscriber goal; and
producing the data in accordance with the subscriber goal.

2. The method of claim 1, further comprising publishing the data produced in accordance with the subscriber goal to an interface communicatively coupled to a data-centric middleware, the data-centric middleware providing the data to one or more subscribers.

3. The method of claim 1, wherein the subscriber goal is selected from a plurality of subscriber goals received from a plurality of subscribers.

4. The method of claim 1, wherein the subscriber goal is an optimized subscriber goal received from a data-centric middleware.

5. The method of claim 4, wherein the data-centric middleware provides the optimized subscriber goal by performing operations comprising:
receiving, from a plurality of subscribers, a plurality of subscriber goals related to the data;
identifying similar subscriber goals from the plurality of subscriber goals;
grouping the similar subscriber goals;
generating the optimized subscriber goal from the grouped similar goals; and
communicating the optimized subscriber goal as part of the subscription request.

6. The method of claim 1, wherein the configuring of the resource allocations of the set of logic comprises signaling a resource manager to modify the resources allocated to the set of logic.

7. The method of claim 1, wherein the subscriber goal is independent of a manner in which the resource allocations are configured.

8. A system comprising:
one or more processors configured to include:
a production monitor to receive a subscription request for data including a subscriber goal, the subscriber goal specifying an outcome with respect to production of the data, the production monitor further configured to identify a set of logic used in the system to produce the data, the production monitor further to configure resource allocations of the set of logic such that the data is produced in accordance with the subscriber goal; and
a publication interface to publish the data produced in accordance with the subscriber goal.

9. The system of claim 8, further comprising a routing module configured to:
access the published data from the publication interface; and
provide the published data to a plurality of subscribers, the routing module being communicatively coupled to the publication interface.

10. The system of claim 9, wherein the data is provided to each of the plurality of subscribers in accordance with an individual goal of each subscriber of the plurality of subscribers.

11. The system of claim 8, further comprising an optimization module configured to provide the subscriber goal to the production monitor.

12. The system of claim 11, wherein the optimization module provides the subscriber goal by performing operations comprising:
receiving, from a plurality of subscribers, a plurality of subscriber goals related to the data;
generating an optimized subscriber goal from the plurality of subscriber goals; and
communicating the optimized subscriber goal to the production monitor as part of the subscription request.

13. The system of claim 8, further comprising a resource manager configured to manage resource allocations of the set of logic.

14. The system of claim 13, wherein the production monitor configures the resource allocations of the set of logic by causing the resource manager to modify the resource allocations of the set of logic.

15. The system of claim 13, wherein the production monitor configures the resource allocations by performing operations comprising:
monitoring the production of the data;
determining that the production of the data is not in accordance with the subscriber goal;
signaling the resource manager to adjust the resource allocations of the set of logic; and
determining that the adjusted resource allocations result in production of the data in accordance with the subscriber goal.

16. The system of claim 8, wherein the production monitor is further configured to receive an additional subscriber goal, the production monitor configuring the resource allocations of the set of logic such that the data is produced in accordance with the subscriber goal and the additional subscriber goal.

17. The system of claim 8, wherein the subscriber goal relates to a characteristic of the data.

18. The system of claim 8, wherein the subscriber goal involves an operational constraint for the system.

19. The system of claim 8, wherein the production monitor is further configured to access an administrative goal, the production monitor configuring the resource allocations of the set of logic such that the data is produced in accordance with the subscriber goal and the administrative goal.

20. A non-transitory machine-readable storage medium embodying instructions that, when executed by at least one processor of a machine, cause the machine to perform operations comprising:
receiving a subscription request for data including a subscriber goal, the subscriber goal specifying an outcome with respect to production of the data;
identifying a set of logic used by a publisher to produce the data;
configuring resource allocations of the set of logic such that the data is produced in accordance with the subscriber goal; and
producing the data in accordance with the subscriber goal.
